(19) United States
(12) Patent Application Publication
(10) Pub. No.: US 2025/0382203 A1
(43) Pub. Date: Dec. 18, 2025

(54) RECOVERY OF FLUORIDE FROM FLUORIDE-CONTAINING WASTE WATER THROUGH MEMBRANE SEPARATION

(71) Applicant: Ecolab USA Inc., Saint Paul, MN (US)

(72) Inventor: Seong-Hoon Yoon, Naperville, IL (US)

(21) Appl. No.: 19/233,914

(22) Filed: Jun. 10, 2025

Related U.S. Application Data
(60) Provisional application No. 63/660,226, filed on Jun. 14, 2024.

(51) Int. Cl. C02F 1/44; B01D 61/24; B01D 61/36; B01D 69/02; B01D 69/08; C02F 1/66; C02F 101/14; C02F 103/34

(52) U.S. Cl. CPC C02F 1/448; B01D 61/246; B01D 61/362; B01D 69/02; B01D 69/08; C02F 1/44; C02F 1/66; B01D 2311/04; B01D 2313/243; B01D 2313/26; B01D 2325/38; C02F 2101/14; C02F 2103/346

(57) ABSTRACT

Systems and techniques for removing fluoride from waste water may involve acidifying a waste water that includes fluoride ions to form hydrofluoric acid. After acidifying the waste water, the acidified waste water can contact a first side of a membrane to cause at least a portion of the hydrofluoric acid to pass through the membrane to a second side of the membrane. The second side of the membrane can be contacted with a collection fluid to collect the hydrofluoric acid passing through the membrane. A treated wastewater having a reduced concentration of fluoride ions can be discharged from a housing containing the membrane. The collection fluid having collected the hydrofluoric acid passing through the membrane can also be discharged from the housing containing the membrane. In some applications, the collection fluid having collected the hydrofluoric acid can be processed to separate and recover the hydrofluoric acid for subsequent use.

### RELATED APPLICATION

This application claims the benefit of U.S. Provisional Application No. 63/660,226, filed Jun. 14, 2024, the entire contents of which are incorporated herein by reference.

### TECHNICAL FIELD

This disclosure relates to membrane systems and techniques and, more particularly, to membrane systems and techniques for removing fluoride from waste water.

### BACKGROUND

Hydrofluoric acid etching is a form of wet etching that uses hydrofluoric acid to etch out surfaces. Hydrofluoric acid etching is capable of etching materials such as amorphous silicon dioxide, quartz, and glass at very high etch rates. In the semiconductor industry, hydrofluoric acid is used to remove silicon dioxide layers from wafer surfaces during the microfabrication process. After etching, the silicon wafer may be rinsed with deionized water, producing a fluoride-containing waste water.

The most common method for treating fluoride-containing wastewater is the so-called precipitation/coagulating/flocculation sedimentation technique. In this method, hydrated lime (calcium hydroxide) is typically used as a calcium source for forming calcium fluoride. The generated calcium fluoride is formed as a fine powder that is suspended in the resulting solution. Accordingly, the solution may be treated by adding coagulant and coagulant aid to coagulate, flocculate and precipitate the compound. The resulting precipitate can be filtered or settled from the water.

Treating fluoride-containing wastewater through calcium precipitation can require the use of large amounts of calcium agent to reduce the fluoride concentration in the effluent below levels required for environmental discharge. Moreover, the technique can generate large quantities of calcium fluoride sludge that need to be disposed of in a landfill. This adds cost and environmental impact to the overall treatment process.

### SUMMARY

In general, this disclosure is directed to membrane separation systems and techniques for removing fluoride ions from fluoride-containing wastewater, allowing the fluoride ions to be recovered from the waste water and optionally regenerated into hydrofluoric acid. In an aqueous wastewater, fluorine may be present in the form of its dissociated negative ion fluoride. The fluoride ions in the water are in equilibrium with hydrogen fluoride, which is also referred to as hydrofluoric acid. Hydrofluoric acid is a comparatively volatile molecule that is in gaseous form under ordinary temperature and pressure conditions. In accordance with some example techniques described herein, water containing fluoride ions may be acidified to form hydrofluoric acid. Acidifying the water can shift the equilibrium reaction between hydrogen ions and fluoride ions, increasing the amount of hydrogen fluoride and reducing the amount of unbound fluoride present in the water. The resulting acidified water with increased concentration of hydrofluoric acid (as compared to prior to being acidified) can be supplied to a separation membrane.

Within a housing containing the membrane, the acidified water can contact one side of the membrane while a collection fluid contacts an opposite side of the membrane. The membrane may be selected as one that allows hydrofluoric acid to pass through the membrane as gas while rejecting water and/or other chemical compounds present in the water being treated. The hydrofluoric acid can be collected by the collection fluid and discharged from the membrane housing while the residual water with reduced concentration of hydrofluoric acid and fluoride ions is separately discharged from the membrane housing. In this way, the concentration of fluoride in the fluoride containing water can be reduced.

A variety of different collection of fluids can be used to collect hydrofluoric acid passing through a membrane as part of a water purification technique. As one example, a gaseous collection fluid can be passed on an opposite side of the membrane from the side of the membrane contacted with the acidified water containing hydrofluoric acid. The gaseous collection fluid may be selected as a gas inert to hydrofluoric acid, such that the inert gas does not react with the hydrofluoric acid. The inert gas with intermixed hydrofluoric acid can be discharged from the membrane housing for further processing. For example, the inert gas intermixed with hydrofluoric acid passing through the membrane can be contacted with a neutralizing liquid having a pH greater than that of hydrofluoric acid. Combining the gas intermixed with hydrofluoric acid with a neutralizing liquid can cause the hydrofluoric acid to dissociate into proton (H⁺) and fluoride ions in the liquid phase, allowing the formation of a fluoride salt.

In another example, a liquid collection fluid can be passed on an opposite side of the membrane from the side of the membrane contacted with the acidified water containing hydrofluoric acid. The liquid collection fluid can be a neutralizing liquid having a pH greater than that of hydrofluoric acid. In use, the hydrofluoric acid carried with the acidified water can pass through the membrane and can combine with the neutralizing liquid. The neutralizing liquid can cause the hydrofluoric acid to dissociate into hydrogen and fluoride in the liquid phase, allowing the formation of a fluoride salt. The neutralizing liquid having collected the hydrofluoric acid passing through the membrane (with the hydrofluoric acid having dissociated into a fluoride salt) can exit the housing containing the membrane.

In one example, a method is described that includes acidifying a waste water comprising fluoride ions to form hydrofluoric acid and, after acidifying the waste water, contacting a first side of a membrane with the waste water and thereby causing at least a portion of the hydrofluoric acid to pass through the membrane to a second side of the membrane. The method also involves contacting the second side of the membrane with a collection fluid to collect the hydrofluoric acid passing through the membrane. The method further includes discharging from a housing containing the membrane a treated wastewater having a reduced concentration of fluoride ions and discharging from the housing containing the membrane the collection fluid having collected the hydrofluoric acid passing through the membrane.

In another example, a system is described that includes an acid pump configured to fluidly connect to an acid source and to pump acid into a waste water comprising fluoride ions to acidify the waste water and form hydrofluoric acid. The system also includes a waste water pump configured to pump the waste water to a feed inlet of a housing. The example system further includes a collection fluid source containing a collection fluid configured to be placed in fluid communication with a collection fluid inlet of the housing. According to the example, the system also includes a membrane contained in the housing, where the membrane is configured to contact waste water received from the waste water source, allow hydrofluoric acid to pass through the membrane while excluding passage of water molecules, and contact collection fluid received from the collection fluid source on an opposite side of the membrane, thereby causing the collection fluid to collect the hydrofluoric acid passing through the membrane.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example membrane separation system for removing fluoride from a fluoride-containing water source, such as a fluoride-containing waste water generated during an etching process utilizing hydrofluoric acid.

FIG. 2 is a conceptual diagram of an example configuration of the system from FIG. 1 where the system is configured to utilize an inert gas as a collection fluid.

FIG. 3 is a conceptual diagram of an example configuration of the system from FIG. 1 where the system is configured to utilize a neutralizing liquid as a collection fluid.

FIG. 4 is a conceptual illustration of hydrogen fluoride passing through a membrane according to some example systems and techniques of the disclosure.

FIG. 5 is a block flow diagram of an example technique for removing fluoride from fluoride-containing water, such as fluoride-containing waste water.

### DETAILED DESCRIPTION

This disclosure is generally directed to systems and technique for removing fluoride ions from fluorine-containing waste water using a membrane separation device. The membrane separation device may be a nanofiltration membrane (NF), an ultrafiltration membrane (UF), a microfiltration membrane (MF) and/or or other type of membrane separation device that allows selective passage of hydrogen fluoride molecules while excluding water and other larger molecules. In different examples, the membrane used may be a spiral wound type of membrane module, hollow-fiber membrane module, tubular type membrane module, and/or plate type membrane module.

Although the membrane separation processes and systems described herein can be used for any desired application where fluoride ions are desirably separated from a bulk water, the processes and systems may commonly be used to process fluoride-containing waste water to separate the fluoride ions from residual water. Waste water can be water that has been used as part of a prior industrial process and contains one or more chemical compounds desirably removed to recover the chemical compound(s) and/or to make the residual water suitable for further processing and/or environmental discharge.

In some examples, the fluoride-containing water processed using systems and techniques according to the disclosure is a fluoride-containing waste water generated as part of a chemical etching process. Fluoride is commonly used in industries such as the semiconductor, solar cell, glass, metal plating, and chemical industries. For example, in the semiconductor fabrication industry, fluoride is used as a silicon layer etchant. Common sources of fluoride used in etching processes include hydrofluoric acid (HF) and buffered oxide etch (BOE) containing ammonium bifluoride (NH4-HF2). Fluoride can be used in wet etching processes as well as plasma etching processes. In either case, after etching, the etched work piece may be contacted with water to remove etched particles and residual etchant chemical. A fluoride-containing waste water produced from the etching process may be processed using systems and techniques described herein to reduce the concentration of fluoride in the waste water stream. This can reduce the concentration of fluoride in the waste water to a level below that required a regulatory agency for discharge of the waste water to the environment.

In some examples, the waste water treated using a membrane separation process according to the disclosure is a waste water containing fluoride ions (e.g., dissociated fluoride in equilibrium with hydrofluoric acid (HF)) and mixed acid etchant (MAE) waste.

Waste water containing HF and MAE waste may be generated during silicon wafer manufacturing and can include a mixture of acids, such as hydrofluoric acid, nitric acid, and/or acetic acid. The waste water can also include dissolved silica (SiO₂).

Independent of the source of the fluoride in the fluoride-containing waste water, in some examples, the concentration of fluoride ions in the waste water is greater than 50 ppm, such as greater than 100 ppm, greater than 200 ppm, greater than 500 ppm, greater than 1000 ppm, greater than 1500 ppm, greater than 2000 ppm, greater than 5,000 ppm, greater than 10,000 ppm, greater than 15,000 ppm, or greater than 20,000 ppm. For example, the concentration of fluoride ions in the waste water may be within a comparatively low range, such as from 50 ppm to 2000 ppm, or from 100 ppm to 1000 ppm, or may be in a comparatively high range, such as from 2000 ppm to 20,000 ppm, such as from 5,000 ppm to 20,000 ppm. The fluoride-containing waste water may additionally or alternatively include colloidal silica (e.g., within a range from 1 ppm to 2000 ppm, such as from 50 ppm to 1000 ppm, such as from 100 ppm to 500) and/or reactive silica, a soluble molecule containing silicon such as silicic acid (e.g., within a range from 1 ppm to 2000 ppm, such as from 50 ppm to 1000 ppm, such as from 100 ppm to 500).

In general, this disclosure describes systems and techniques for removing fluoride ions from a water stream through selective passage of hydrofluoric acid through a membrane into a collection fluid while water is substantially blocked from passage through the membrane. The water containing fluoride ions that contacts the membrane may typically be in liquid form although, in other examples, may be processed as a gas phase stream (water vapor) or mixed gas-liquid phase stream. The water stream containing fluoride ions can be acidified before contacting the membrane to drive the equilibrium reaction toward the formation of hydrofluoric acid. The hydrofluoric acid can pass through the membrane for collection by a collection fluid flowing on an opposite side of the membrane. In different examples, the membrane may be selected as a porous hydrophobic membrane (in which hydrofluoric acid molecules pass through the pores of the membrane while repelling water molecules) or a non-porous membrane (in which hydrofluoric acid molecules pass through spaces between polymer chains at slower rates than when using a porous membrane).

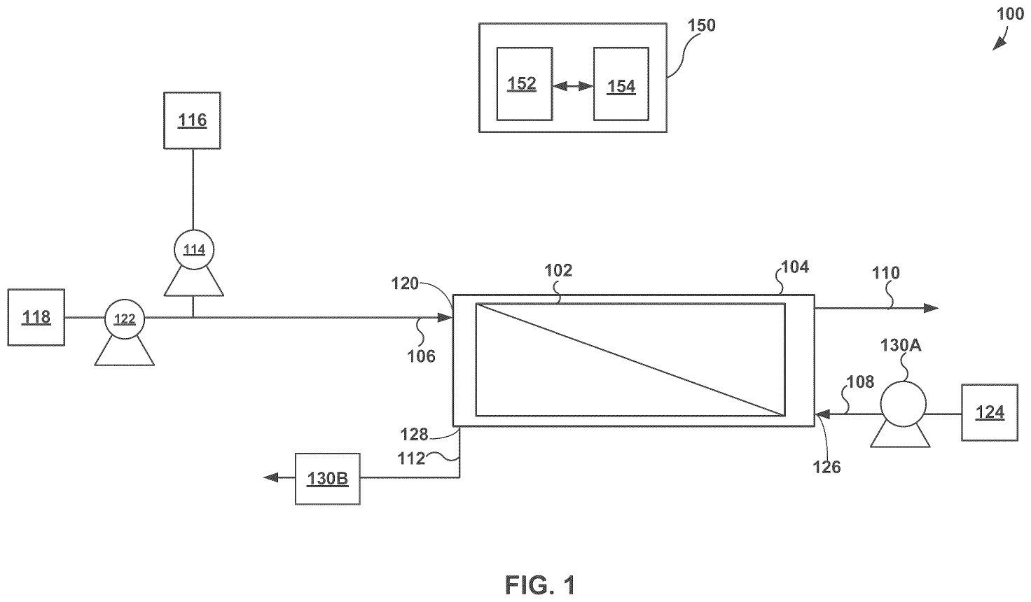

FIG. 1 is a conceptual diagram illustrating an example membrane separation system 100 for removing fluoride from a fluoride-containing water source, such as a fluoride-containing waste water generated during an etching process utilizing hydrofluoric acid. System 100 includes a membrane 102 contained within a housing 104 that receives a feed stream 106 on one side of the membrane and a collection fluid stream 108 on an opposite side of the membrane. During operation of system 100, membrane 102 can be contacted with the feed stream of acidified water containing fluoride (e.g., in the form of hydrofluoric acid) to reduce the concentration of fluoride in the water by passage of the hydrofluoric acid across the membrane. This can produce a treated water stream 110 having a reduced concentration of fluoride ions (as compared to feed stream 106) that is discharged from housing 104. The collection fluid stream 108 on the opposite side of membrane 102 can collect the hydrofluoric acid passing across the membrane and convey the collected hydrofluoric acid out of housing 104 as a collection fluid stream 112 having collected hydrofluoric acid (e.g., in the form of a hydrofluoric acid, a fluoride salt, or other fluorine-containing species).

In the example of FIG. 1, system 100 include one or more acid pumps 114 configured to fluidly connect to one or more acid source 116. Acid pump 114 is operable to introduce acid into fluoride-containing water from fluoride-containing water source 118 (e.g., upstream of membrane 102). In different examples, the acid from source 116 may be introduced in line into a flowing stream of water (e.g., with the combined stream actually passing through a static mixer to intermix the acid in the water) or the acid from source 116 may be introduced into a static volume of water from source 118. For example, water from source 118 may be introduced into a tank that also receives acid from source 116 pump via acid pump 114. The water in the tank may be mixed to achieve a substantially uniform distribution of the asset and pH across the volume of water. In either case, the resulting acidified fluoride-containing water can be conveyed to housing 104 and membrane 102.

Example acids that may be used as acid source 116 include strong mineral acids such as sulfuric acid, phosphoric acid, nitric acid, hydrochloric acid, sulfamic acid, and combinations thereof and/or strong organic acids such as methane sulfonic acid, ethane sulfonic acid, propane sulfonic acid, butane sulfonic acid, xylene sulfonic acid, benzene sulfonic acid, oxalic acid, citric acid, and combinations thereof. The relative amount of acid introduced into the fluoride-containing water can vary depending on the pH of the incoming water and the target pH of the resulting acidified water.

In practice, fluoride ions (F−) in water are in equilibrium with volatile hydrogen fluoride (HF). As the pH is lowered, more F− ions turn to volatile form, HF. For example, if the pH of the water is set to be the same as pKa (equal to 3.17), the concentration ratio of [HF] /[F−] is 1. However, if the pH of the water is lowered to one unit less than pKa (down to a pH of 2.17) the concentration ratio of [HF] /[F−] increases to ten and as a result fluoride becomes much more volatile. Thus, the volatility of F− and the relative proportion of HF molecules to F− ions in the water being treated can be controlled by controlling the pH. This equilibrium balance is represented by the following equilibrium equation.

$${H}^{+} + {F}^{-} ⇌ HF \qquad Equation 1$$

In general, as the pH of the fluoride-containing water is lowered, more of the fluoride ions are converted to hydrofluoric acid, increasing the flux across the membrane. In some applications, the pH of the fluoride-containing water is lowered to pH less than 5.0, such as less than 4.0, less than 3.5, less than 3.0, less than 2.5, less than 2.0, less than 1.5, or less than 1.0. For example, the pH of the fluoride-containing water may be reduced through addition of acid from acid source 116 to a pH within a range from 1.0 to 3.0.

Fluoride-containing water from source 118 can be introduced into a feed inlet 120 of housing 104. A pump 122 may be used to draw the fluoride-containing water from source 118, pressurize the water, and deliver the water under pressure to feed inlet 120. Pump 122 may be located upstream or downstream of the location where acid is introduced into the water. Fluoride-containing water may be filtered to remove particulates and other debris from the water prior to being pumped into housing 104 and contacting membrane 102.

System 100 and membrane 102 can be configured for any desired type of membrane separation process. Typically, however, system 100 and membrane 102 may be implemented as a cross flow separation process in which the flow of acidified water is applied tangentially across the membrane surface. As feed flows across the membrane surface, filtrate (hydrofluoric acid) passes through the membrane while water having a reduced concentration of fluoride ions and hydrofluoric acid is formed on the opposite end of the membrane.

System 100 can employ a variety of different types of membranes as membrane 102. Such commercial membrane element types include, without limitation, hollow fiber membrane elements, tubular membrane elements, spiral-wound membrane elements, plate and frame membrane elements, and the like. Membrane 102 may be fabricated from a fluorine-stable polymeric material, such as a fluorine-stable block copolymer based on vinylidene fluoride. Example materials that may be used for membrane 102 including poly(vinylidene fluoride-co-hexafluoro propylene) and fluorinated poly(vinylidene-co-trifluorethylene), P(VDF-TrFE). Membrane 102 may be a porous hydrophobic membrane or a non-porous membrane.

For example, in some implementations, membrane 102 may be a porous hydrophobic membrane constructed of a polymeric material such as polyvinylidene fluoride (PVDF), polytetrafluoroethylene (PTFE), polyethylene (PE), and/or polypropylene (PP). The membrane can have an average pore size less than 1 micron, such as less than 0.2 microns, less than 0.1 microns, or less than 0.05 microns. In some other implementations, membrane 102 may be a nonporous membrane that is constructed of and/or includes polydimethylsiloxane (PDMS) (e.g., PDMS coated on porous membranes to make them non-porous) and/or includes a comparatively thin non-porous membrane (e.g., polyurethane) sandwiched in between two porous membranes (e.g., such as sandwiched between PP and/or PE membranes).

In different applications, membrane 102 can be implemented using a single membrane element or multiple membrane elements depending on the application. For example, multiple membrane elements may be used forming membrane modules that are stacked together, end to end, with inter-connectors joining the permeate tubes of the first module to the permeate tube of the second module, and so on. These membrane module stacks can be housed in pressure vessels (e.g., housing 104). Within the housing, the feed stream can pass into the first module in the stack, which removes a portion of the hydrofluoric acid as the permeate. The partially purified water forms a concentrate stream from the first membrane can then become the feed stream of the second membrane and so on down the stack. The permeate streams from all of the membranes in the stack can be collected in the joined permeate tubes.

Pressure vessels may be arranged in either “stages” or “passes.” In a staged membrane system, the combined concentrate streams from a bank of pressure vessels can be directed to a second bank of pressure vessels where they become the feed stream for the second stage. Commonly, systems have two to three stages with successively fewer pressure vessels in each stage. For example, a system may contain four pressure vessels in a first stage, the concentrate streams of which feed two pressure vessels in a second stage, the concentrate streams of which in turn feeds one pressure vessel in the third stage. This is designated as a “4:2:1” array. In a staged membrane configuration, the combined permeate streams from all pressure vessels in all stages may be collected.

In the example of FIG. 1, system 100 illustrates that collection fluid from a collection fluid source 124 can be supplied to a collection fluid inlet 126 of the housing for contact with membrane 102. Collection fluid can function to collect hydrofluoric acid permeating through membrane 102 and can carry the collected hydrofluoric out of housing 104 via a collection fluid outlet 128. Collection fluid can carry the hydrofluoric acid passing through membrane 102 out of housing 104 as hydrofluoric acid molecules or as a degradation or reaction product of the hydrofluoric acid. For example, the collection fluid may be in the form of a liquid that reacts with hydrofluoric acid passing through membrane 102 to form a fluoride salt, thereby carrying the collected hydrofluoric acid out of housing 104 with the collection liquid in the form of a fluoride salt.

In some examples, a collection fluid pump 130A located upstream of collection fluid inlet 126 is used pressurize collection fluid from source 124 and convey the fluid under pressure through housing 104. In other examples, a vacuum source, such as a collection fluid vacuum pump 130B located downstream of a collection fluid outlet 128 is used to apply a negative pressure that draws collection fluid through housing 104.

In different applications, the collection fluid may or may not react with hydrofluoric acid passing through membrane 102 before carrying the fluorine atoms out of housing 104 with the collection fluid. For example, in some applications, the collection fluid is inert and nonreactive to hydrofluoric acid. In other applications, the hydrofluoric acid dissociates and/or reacts with or in the collection fluid to form fluoride ions, or a salt thereof, that is carried with the collection fluid out of housing 104.

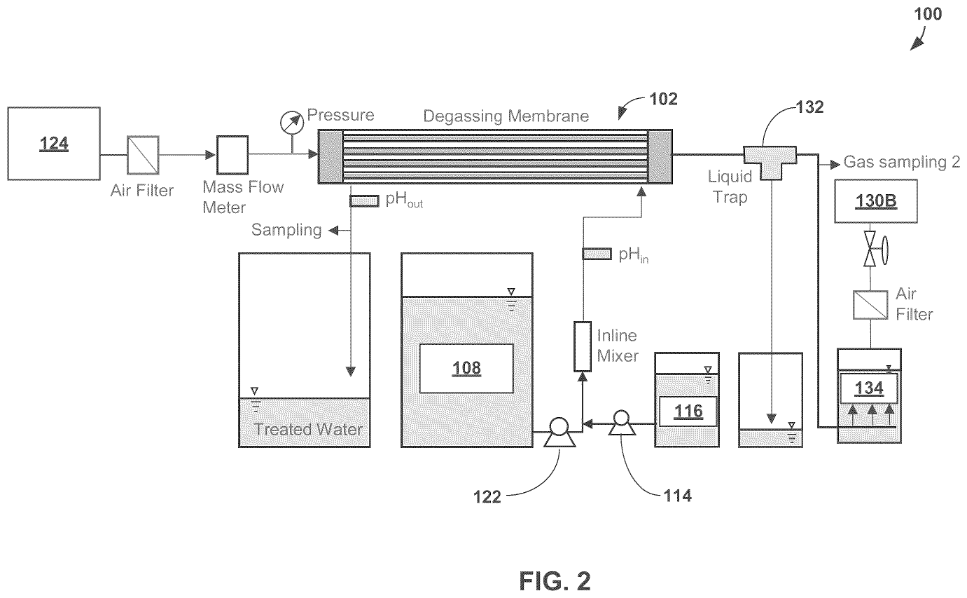

FIG. 2 is a conceptual diagram of an example configuration of system 100 from FIG. 1 where the system is configured to utilize an inert gas as a collection fluid. In the example of FIG. 2, like reference numerals refer to like features discussed above with respect to FIG. 1. In the example of FIG. 2, fluoride-containing water from source 118 is acidified with acid from source 116 to lower the pH of the water and drive the formation of hydrofluoric acid. The acidified water is supplied to one side of membrane 102 while a gaseous collection fluid is supplied to an opposite side of the membrane. The acidified water and gaseous collection fluid may flow in opposite directions (counter flow) relative to the membrane. At least a portion of the hydrofluoric acid in the acidified water can transport across the membrane and enter the collection fluid passing on the opposite side of the membrane.

In the example of FIG. 2, the collection fluid used to collect hydrofluoric acid passing through membrane 102 may be in a gas state. The gas may be inert to hydrofluoric acid such that the gas does not substantially react with the hydrofluoric acid. The gas collection fluid can intermix with the gaseous hydrofluoric acid passing through the membrane to form an intermix stream that is carried over the housing containing membrane 102. Example inert gases that can be used as a collection fluid for system 100 include air (e.g., a mixture of nitrogen, oxygen, and argon), oxygen (O₂), nitrogen (N₂), helium (He), neon (Ne), argon (Ar), krypton (Kr), Xenon (Xe), and the like, and combinations thereof.

After the gaseous collection fluid containing intermixed hydrofluoric acid discharges the housing containing membrane 102, intermixed gas may pass through a liquid trap 132 to separate out and remove liquid carried with the gas flow. Thereafter, the intermixed gas stream may be contacted with a neutralizing liquid 134. For example, the intermixed gas stream containing an inert gas and hydrofluoric acid may be sparged, bubbled, and/or otherwise contacted in intermixed with the neutralizing liquid.

In the illustrated example of FIG. 2, system 100 is configured to convey a gas stream containing the collection fluid intermixed with hydrofluoric acid through a vessel containing the neutralizing liquid with the gas flowing through the static volume of liquid. The gas may be drawn through the neutralization liquid via a vacuum pump 130B. In other configurations, a flowing stream of gas may be intermixed with a flowing stream of neutralization liquid. In either case, after suitably contacting the neutralization liquid, the gas may be separate from the liquid and discharged or recycled back to the collection fluid inlet of the housing containing membrane 102 for one or more additional cycles of reuse. For example, the gaseous collection fluid may flow in a closed loop repeatedly through the housing containing membrane 102 and across the membrane.

Neutralizing liquid 134 may be a liquid having a pH greater than the pH of the gas stream carrying the hydrofluoric acid. Upon the gas stream contacting and/or intermixing with the neutralizing liquid, at least a portion of the hydrofluoric acid may solubilize in the liquid and dissociate into fluoride ions. The fluoride ions may form a salt with cations in the neutralizing liquid. Example neutralizing liquids that can be used include aqueous solutions of alkali metal and alkaline earth metal hydroxides (e.g., sodium hydroxide, potassium hydroxide, calcium hydroxide, magnesium hydroxide), boric acid (B(OH)₃), and the like, and combinations thereof. The hydrofluoric acid can form a salt corresponding to the cation of the neutralizing liquid used, such as sodium fluoride (NaF), potassium fluoride (KF₄), calcium fluoride (CaF₂), and the like.

The concentration of the neutralizing agent in the water forming the neutralizing liquid may vary depending on the concentration of hydrofluoric acid in the collection fluid. The concentration of neutralizing agent can be in stoichiometry excess to the expected concentration of hydrofluoric acid to be carried with the collection fluid. The pH of the neutralizing liquid may be sufficiently high to promote dissociation of the hydrofluoric acid into fluoride ions in the formation of a corresponding fluoride salt. In various examples, the neutralizing liquid has a pH greater than 7.0, such as greater than 9.0, greater than 10.0, greater than 11.0, or greater than 12.0.

The gas collection fluid may be contacted with and/or passed through the neutralizing liquid until the neutralizing liquid has collected a sufficient amount of fluoride and can be topped up with and/or replaced with fresh neutralizing liquid. The point at which the neutralizing liquid may be replaced can correspond to a concentration of fluoride (e.g., fluoride salt) in the neutralizing liquid, which may be measured directly or indirectly. For example, the gas collection fluid may be contacted with and/or passed through the neutralizing liquid until the pH of the neutralizing liquid falls below a threshold indicating the desired replacement of the neutralizing liquid. The threshold pH may be a pH less than 10.0, such as less than 9.5, less than 9.0, less than 8.5, less than 8.0, less than 7.5, or less than 7.0. In some examples, the threshold pH is a pH within a range from 8.0 to 10.5, such as from 9.0 to 10.0. When the pH of the neutralizing liquid crosses threshold, the neutralizing liquid may be replaced. A pH sensor or other sensor may be installed to measure the concentration of fluoride (e.g., fluoride salt) in the neutralizing liquid, or characteristic associated therewith. The neutralizing liquid may also be controlled to a target steady-state condition (e.g., target steady-state pH). An amount of the neutralizing liquid can be periodically or continuously removed from a reservoir containing the liquid through which the gas collection fluid passes while make-up neutralizing liquid lacking accumulated fluoride is added to replace the removed neutralizing liquid, thereby maintaining a substantially steady-state condition.

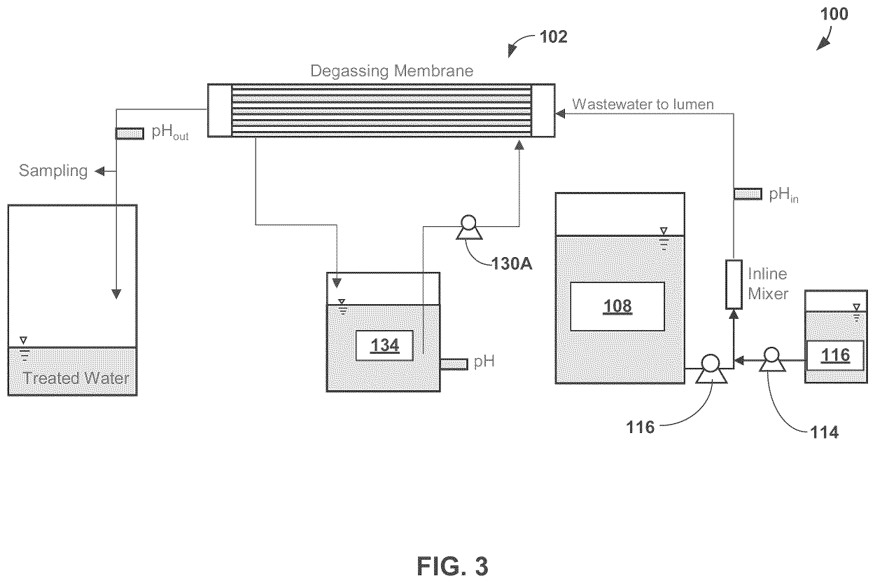

FIG. 3 is a conceptual diagram of an example configuration of system 100 from FIG. 1 where the system is configured to utilize a neutralizing liquid as a collection fluid. In the example of FIG. 3, like reference numerals refer to like features discussed above with respect to FIGS. 1 and 2. Unlike the example of FIG. 2 where a gaseous collection fluid is passed through a housing containing membrane 102 to collect hydrofluoric acid passing across the membrane, the system of FIG. 3 is configured to utilize a neutralizing liquid 134 as the collection fluid. The neutralizing liquid used as the collection fluid in the implementation of FIG. 3 can include any of the neutralizing liquid, and their respective properties (e.g., pH), discussed above.

In the example of FIG. 3, fluoride-containing water from source 118 is acidified with acid from source 116 to lower the pH of the water and drive the formation of hydrofluoric acid. The acidified water is supplied to one side of membrane 102 while a neutralizing liquid functioning as the collection fluid is supplied to an opposite side of the membrane. The acidified water and neutralizing liquid fluid may flow in opposite directions (counter flow) relative to the membrane. At least a portion of the hydrofluoric acid in the acidified water can transport across the membrane and enter the neutralizing liquid passing on the opposite side of the membrane.

As discussed above with respect to FIG. 2, neutralizing liquid 134 may be a liquid having a pH greater than the pH of the gas stream carrying the hydrofluoric acid. After the hydrofluoric acid passing through membrane 102, the hydrofluoric acid can contact and/or intermixing with the neutralizing liquid, causing at least a portion of the hydrofluoric acid may solubilize in the liquid and dissociate into fluoride ions. The fluoride ions may form a salt with cations in the neutralizing liquid.

The neutralizing liquid may be passed through the housing containing membrane 102 a single time (one-pass) or may be passed through the housing a plurality of times (recycled). For example, with neutralizing liquid may be passed through the housing containing membrane 102 to contact the membrane and collect hydrofluoric acid passing through the membrane multiple times in a recycle loop. The neutralizing liquid may be drawn from a tank containing the liquid, pressurized via pump 130A, supplied to the housing containing membrane 102 via collection fluid inlet 126, and returned back to the tank after discharging from the housing via collection fluid outlet 128.

The neutralizing liquid may continue to be used (recycled to membrane 102) until the neutralizing liquid has collected a sufficient amount of fluoride and can be topped up with and/or replaced with fresh neutralizing liquid. The point at which the neutralizing liquid may be replaced can correspond to a concentration of fluoride (e.g., fluoride salt) in the neutralizing liquid, which may be measured directly or indirectly, as discussed above with respect to FIG. 2. For example, the neutralizing liquid may be passed through the housing containing membrane 102 and can contact the membrane until the pH of the neutralizing liquid falls below a threshold indicating desired replacement of the neutralizing liquid. The threshold pH may be a pH less than 10.0, such as less than 9.5, less than 9.0, less than 8.5, less than 8.0, less than 7.5, or less than 7.0. In some examples, the threshold pH is a pH within a range from 8.0 to 10.5, such as from 9.0 to 10.0. When the pH of the neutralizing liquid crosses threshold, the neutralizing liquid may be replaced. A pH sensor or other sensor may be installed to measure the concentration of fluoride (e.g., fluoride salt) in the neutralizing liquid, or characteristic associated therewith. The neutralizing liquid may also be controlled to a target steady-state condition (e.g., target steady-state pH). An amount of the neutralizing liquid can be periodically or continuously removed from a reservoir containing the liquid while make-up neutralizing liquid lacking accumulated fluoride is added to replace the removed neutralizing liquid, thereby maintaining a substantially steady-state condition.

In the example of system 100 in both FIGS. 2 and 3, the fluoride-containing water to be treated may have a fluoride concentration greater than 50 ppm, such as greater than 100 ppm, greater than 200 ppm, greater than 500 ppm, greater than 1000 ppm, greater than 1500 ppm, or greater than 2000 ppm. After treatment and membrane separation, the resulting treated water will have a reduced fluoride concentration. The concentration of fluoride in the water after acidification and membrane separation may be reduced at least 25% compared to the concentration prior to such treatment, such as at least 50%, at least 60%, at least 70%, at least 80%, or at least 90%. For example, the treated water produced according to the systems and techniques of the disclosure may have a fluoride concentration less than 200 ppm, such as less than 100 ppm, less than 50 ppm, less than 40 ppm, less than 30 ppm, less than 20 ppm, less than 10 ppm, or less than 5 ppm. The resulting treated water may be reused in an industrial process, discharged to the environment, or otherwise disposed. In some applications, the resulting treated water is pH after membrane separation (e.g., by adding a base to increase the pH of the treated water).

In the example of system 100 in both FIGS. 2 and 3, the neutralizing liquid containing recovered fluorine (e.g., in the form of a fluoride salt) can be processed to regenerate hydrofluoric acid. In some applications, the neutralizing liquid may be transported to a processing facility that regenerates hydrofluoric acid from the neutralizing liquid. Aqueous or anhydrous hydrofluoric acid may be generated from the neutralizing liquid. In some applications, the regenerated hydrofluoric acid is supplied to an industrial process generating the fluoride-containing waste water, thereby providing a closed loop in which the hydrofluoric acid is used resulting in a fluoride-containing waste water, fluoride is recovered from the waste water, and hydrofluoric acid is regenerated or reuse.

The systems and techniques of the disclosure may be implemented under the direction and control of an operator and/or through the use of one or more system controllers. With reference to FIG. 1, for example, system 100 may include a controller 150 that can be communicatively coupled to various components within system 100 to manage the overall system. For example, system 100 may include one or more sensors (e.g., temperature sensor, pressure sensor, flow sensor, pH sensor) that can measure one or more characteristics of any stream entering or exiting housing 104.

For example, controller 150 can be communicatively connected to one or more sensors, one or more pumps, and optionally any other controllable components or sensors that may be desirably implemented in system 100. Controller 150 can include processor 152 and memory 154. Controller 150 can communicate with controllable components in system 100 via connections. For example, signals generated by each sensor may be communicated to controller 150 via a wired or wireless connection. Memory 154 can store software for running controller 150 and may also store data generated or received by processor 152, e.g., from the one or more sensors. Processor 152 can run software stored in memory 154 to manage the operation of system 100.

In some examples, system 100 includes a pH sensor that can measure a pH of the incoming water to be treated and/or a pH of the water after addition of an acid. Controller 150 can control acid pump 114 to adjust (e.g., increase, decrease) the amount of acid introduced into the waste water based on measured pH information and a target pH. Controller 150 may control acid pump 114 to deliver an amount of acid to the water effective to achieve (e.g., equal or exceed) the target pH.

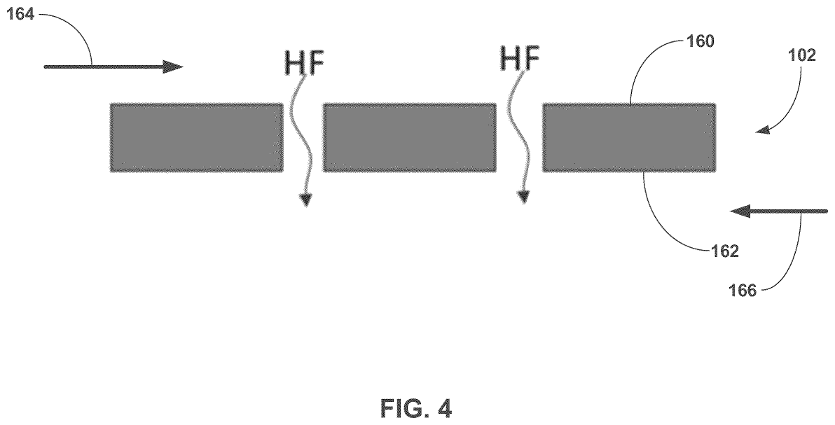

FIG. 4 is a conceptual illustration of hydrogen fluoride passing through a membrane 102 according to some example systems and techniques of the disclosure. As shown in this illustration, membrane 102 has a first side 160 and a second side 162 opposite the first side. An acidified fluoride-containing water stream 164 is conveyed across and in contact with the first side 160 of membrane 102. In this example, membrane 102 is illustrated as a porous hydrophobic membrane that includes porous allowing passage of hydrofluoric acid molecules while rejecting water molecules. At least a portion of the hydrofluoric acid molecules in stream 164 pass through the membrane to the second side 162 of the membrane. A collection fluid stream 166 is conveyed across and in contact with the second side 16 of membrane 162. The collection fluid collects the hydrofluoric acid molecules passing through the membrane and can convey the collected hydrofluoric acid out of the housing containing membrane 102.

When membrane 102 is configured as a tubular hollow fiber membrane, first side 160 of membrane 102 may define an outer shell side of the hollow fiber membrane and second side 162 of the membrane may define an inner tube side of the hollow fiber membrane. Alternatively, first side 160 of membrane 102 may define an inner tube side of the hollow fiber membrane and second side 162 of the membrane may define an outer shell side of the hollow fiber membrane.

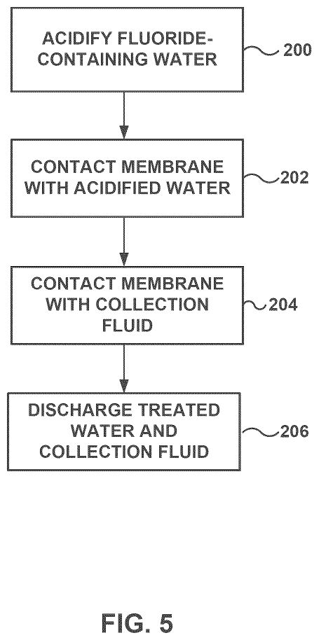

FIG. 5 is a block flow diagram of an example technique for removing fluoride from fluoride-containing water, such as fluoride-containing waste water. In the example of FIG. 5, the technique involves receiving a fluoride-containing waste water from a source, such as a waste water from a silicon etching process, and acidifying the waste water to form hydrofluoric acid (step 200). A strong acid may be added to the waste water to shift the equilibrium reaction between dissociated fluoride ions and hydrofluoric acid toward the generation of hydrofluoric acid. In some examples, the pH of the waste water is lowered so at least 40 mol % of the fluorine atoms in the waste water are in the form of hydrofluoric acid, such as at least 50 mol %, at least 60 mol %, at least 70 mol %, at least 80 mol %, at least 90 mol %, or at least 95 mol %.

The example technique of FIG. 5 also involves introducing the acidified waste water into a membrane housing and contacting a first side of the membrane with the acidified waste water (step 202). In different examples, the membrane may be a porous hydrophobic membrane or a non-porous membrane. The membrane can be a fluorine-stable polymeric membrane. In some applications, the membrane is a hollow fiber membrane. At least a portion of the hydrofluoric acid in the acidified water can pass through the membrane to a second side of the membrane, such as at least 20 mol % of the hydrofluoric acid in the acidified waste water, at least 30 mol %, at least 40 mol %, at least 50 mol %, at least 60 mol %, at least 70 mol %, at least 80 mol %, or at least 90 mol %.

The technique of FIG. 5 also involves contacting the second side of the membrane with a collection fluid to collect the hydrofluoric acid passing through the membrane (step 204). In some examples, the collection fluid is a gas, such as an inert gas that does not react with the hydrofluoric acid passing through the membrane. In these examples, the collection fluid can act as a carrier gas that carries hydrofluoric acid molecules passing through the membrane out of the membrane housing for further recovery. For example, after exiting the membrane housing, the inert gas carrying the hydrofluoric acid molecules can be passed into and/or through a neutralizing liquid to form a fluoride salt in the neutralizing liquid from the hydrofluoric acid molecules. This can remove a majority of the hydrofluoric acid molecules from the inert gas, such as such as at least 50 mol % of the hydrofluoric acid molecules in the inert gas, such as at least 70 mol %, at least 80 mol %, at least 90 mol %, at least 95 mol %, or at least 98 mol %. In other examples, the collection fluid is a neutralizing liquid, such as an alkaline or basic liquid, that reacts with the hydrofluoric acid passing through the membrane to form a fluoride salt. The neutralizing liquid can convey the collected hydrofluoric acid (e.g., in the form of a fluoride salt) out of the membrane housing.

The example technique also involves discharging the treated wastewater having a reduced concentration of fluoride ions and discharging the collection fluid having collected the hydrofluoric acid passing through the membrane from the membrane housing (step 206). The treated wastewater may be reused, further processed, or discharged to the environment.

Various examples have been described. These and other examples are within the scope of the following claims.

1. A method comprising:
acidifying a waste water comprising fluoride ions to form hydrofluoric acid;
after acidifying the waste water, contacting a first side of a membrane with the waste water and thereby causing at least a portion of the hydrofluoric acid to pass through the membrane to a second side of the membrane;
contacting the second side of the membrane with a collection fluid to collect the hydrofluoric acid passing through the membrane;
discharging from a housing containing the membrane a treated wastewater having a reduced concentration of fluoride ions; and
discharging from the housing containing the membrane the collection fluid having collected the hydrofluoric acid passing through the membrane.

2. The method of claim 1, wherein the collection fluid comprises a gas that is inert to hydrofluoric acid, and the discharging the collection fluid from the housing comprises discharging the gas intermixed with hydrofluoric acid.

3. The method of claim 2, further comprising, after discharging the gas intermixed with hydrofluoric acid, introducing the gas intermixed with hydrofluoric acid into a neutralizing liquid to form a fluoride salt.

4. The method of claim 2, wherein:
the membrane comprises a hollow fiber membrane having an inner tube side and an outer shell side;
contacting a first side of a membrane with the waste water comprises contacting the outer shell side of the hollow fiber membrane with the waste water; and
contacting the second side of the membrane with the collection fluid comprises contact the inner tube side of the hollow fiber member with the gas.

5. The method of claim 2, wherein:
contacting the first side of the membrane with the waste water comprises pumping the waste water under pressure into the housing; and
contacting the second side of the membrane with the collection fluid comprises applying a vacuum to a collection fluid outlet of the housing to draw the gas under vacuum pressure through the housing.

6. The method of claim 1, wherein:
the collection fluid comprises a neutralizing liquid;
contacting the second side of the membrane with the collection fluid to collect the hydrofluoric acid passing through the membrane comprises forming a fluoride salt in neutralizing liquid; and
discharging the collection fluid having collected the hydrofluoric acid passing through the membrane from the housing comprises discharging the neutralizing liquid comprising fluoride salt from the housing.

7. The method of claim 6, wherein the neutralizing liquid has a pH greater than 9.0.

8. The method of claim 6, wherein the neutralizing liquid is selected from the group consisting of sodium hydroxide, potassium hydroxide, boric acid, and combinations thereof.

9. The method of claim 6, further comprising recycling the neutralizing liquid through the housing to contact the second side of the membrane a plurality of times, thereby increasing a concentration of the fluoride salt in the neutralizing liquid with each pass through the housing.

10. The method of claim 6, wherein:
the membrane comprises a hollow fiber membrane having an inner tube side and an outer shell side;
contacting a first side of a membrane with the waste water comprises contacting the inner tube side of the hollow fiber membrane with the waste water; and
contacting the second side of the membrane with the collection fluid comprises contact the outer shell side of the membrane with the neutralizing liquid.

11. The method of claim 1, wherein acidifying the waste water comprises reducing a pH of the waste water to less than 4.0.

12. The method of claim 1, wherein the waste water comprising fluoride ions comprises waste water from a silicon etching process.

13. The method of claim 1, wherein a concentration of fluoride ions in the waste water is greater than 200 ppm.

14. The method of claim 1, wherein the membrane is a porous hydrophobic membrane or a non-porous membrane.

15. The method of claim 1, wherein contacting the first side of the membrane with the waste water and contacting the second side of the membrane with the collection fluid comprises flowing the waste water and the collection fluid in countercurrent directions across the membrane.

16. The method of claim 1, further comprising recovering the hydrofluoric acid from the collection fluid.

17. A system comprising:
an acid pump configured to fluidly connect to an acid source and to pump acid into a waste water comprising fluoride ions to acidify the waste water and form hydrofluoric acid;
a waste water pump configured to pump the waste water to a feed inlet of a housing;
a collection fluid source containing a collection fluid configured to be placed in fluid communication with a collection fluid inlet of the housing; and
a membrane contained in the housing, wherein the membrane is configured to contact waste water received from the waste water source, allow hydrofluoric acid to pass through the membrane while excluding passage of water molecules, and contact collection fluid received from the collection fluid source on an opposite side of the membrane, thereby causing the collection fluid to collect the hydrofluoric acid passing through the membrane.

18. The system of claim 17, wherein the collection fluid source comprises a gas that is inert to hydrofluoric acid, and further comprising a vacuum source positioned downstream of the housing and configured to draw the collection fluid from the collection fluid source into the collection fluid inlet of the housing.

19. The system of claim 18, further comprising a reservoir containing a neutralizing liquid positioned downstream of the housing, wherein the housing is configured to discharge the collection fluid having collected the hydrofluoric acid passing through the membrane and introduce the collection fluid into the neutralizing liquid, thereby forming a fluoride salt in the neutralizing liquid.

20. The system of claim 17, wherein the collection fluid source comprises a neutralizing liquid, and further comprising a pump configured to pump the neutralizing liquid from the collection fluid source into the collection fluid inlet of the housing.
